(19) United States
(12) Patent Application Publication
(10) Pub. No.: US 2002/0092169 A1
(43) Pub. Date: Jul. 18, 2002

(54) Foil cutter

(76) Inventor: Edward Kilduff, New York, NY (US)

Correspondence Address: Perry J. Saidman, Esq., SAIDMAN DesignLaw Group, Suite 510, 1110 BONIFANT STREET, Silver Spring, MD, 20910, US

(21) Appl. No.: 09/759,087

(22) Filed: Jan. 12, 2001

(51) Int. Cl. B67B 7/00

(52) U.S. Cl. 30/1.5; 30/278

(57) ABSTRACT

A foil cutter for removing the foil wrapping from the neck of a wine bottle has a generally circular, disc-shaped body including a substantially circular interior cavity with a plurality of cutting wheels projecting into the cavity. When the foil cutter is at rest, the circular interior cavity fits loosely over the mouth of the wine bottle. The foil cutter body is flexible to permit a partial collapsing of the circular interior cavity to bring the cutting wheels into cutting relationship with the foil wrap.

### BACKGROUND OF THE INVENTION

1. Field of the Invention

This invention relates to a cutter for use in removing the foil from the neck of a wine bottle.

2. Description of Related Art

Wine bottles are sealed by a cork forcibly inserted within the neck. In order to protect the cork from foreign matter, and to inhibit drying of the cork, it is covered, often by a wax plug but more typically by a metal foil adhered to the upper end of the neck of the bottle and covering its mouth. When the wine bottle is opened, the foil must be removed to gain access to the cork. Removal of the foil is accomplished in several ways.

Many people ignore the foil and simply insert a corkscrew through it into the cork. When the cork is pulled through the foil, the foil is torn, leaving jagged edges exposed. The jagged edges are unsightly, catch on clothing and other items, and cause the wine to pour erratically, often resulting in spills.

Some use the tip of the corkscrew to rip the foil, pulling away pieces until the foil has been removed. While this method obviates the aforementioned jagged edges, it is laborious and leaves a mangled mass of foil, which must be disposed of.

Others, waiters particularly, cut the foil with a short knife blade, either the one attached to a corkscrew designed for waiters' use or a separate implement. The cutting edge of the blade is applied to the foil just below the top edge of the bottle, and to cut through the foil, the blade is pressed firmly against the neck while traversing a path encircling the neck. This method removes a small cap-shaped portion of the foil, while leaving a cylindrical sleeve of foil attached to the neck. The presence of the sleeve is considered aesthetically pleasing, since, in addition to its functional characteristics, the foil is often quite decorative. Considerable experience is needed to accomplish this feat deftly, experience which is usually outside the realm of most household hosts. And, should the knife slip, injury to the unskilled host is possible.

Foil cutters other than knife blades are known. So far as this invention is concerned, the most pertinent prior art known to the inventor is disclosed in U.S. Pat. No. 4,845,844, issued Jul. 11, 1989, to Allen. Allen discloses several embodiments including a tong-shaped device (FIGS. 7-10) and an oval-shaped cutter (FIG. 13). These comprise two opposing arms, with a pair of cutting wheels mounted on each arm, integrally joined by one or two flexible connectors, each of which comprise slender rods, small in cross-section, which are reverse-bent sharply over a relatively short length. In use, Allen's cutters are held in the hand with each pair of wheels positioned on opposite sides of the wine bottle's neck, the arms are squeezed until the wheels pierce the foil, and the bottle and cutter are rotated in opposite directions. While suitable for their intended purpose, they have the disadvantage that the flexure needed to apply the cutting wheels to the foil is concentrated in a limited portion of the cutter, the aforesaid short length of the connectors, and the flexure occurs primarily in the plane of the connectors and arms. As a consequence, the connectors are susceptible to structural fatigue ultimately leading to breakage. In addition, they are relatively bulky, relatively difficult to store, especially in a pocket as would be necessary for a waiter, and the sharp reverse bend in the connectors can be uncomfortable.

### OBJECTS AND SUMMARY OF THE INVENTION

The present invention overcomes the difficulties described above by providing a foil cutter which is small, easily stored, is comfortable to handle, and is relatively long-lived due to the flexure being transverse the plane of a leaf-spring of the spring and spread over a broad expanse thereof.

It is an object of the invention to provide a foil cutter which is compact, comfortable to hold and use, and easy to handle and store.

It is a further object of the invention to provide a foil cutter that is long lived due to spreading the flexural area of the leaf spring over an extended area.

### BRIEF DESCRIPTION OF THE DRAWINGS

The foregoing and other objects, aspects, uses, and advantages of the present invention will be more fully appreciated as the same becomes better understood from the following detailed description of the present invention when viewed in conjunction with the accompanying drawings, in which:

FIG. 1 is a perspective view that illustrates the preferred embodiment of the foil cutter of the present invention;

FIG. 2 is a top view of the foil cutter of FIG. 1;

FIG. 3 is a front view of the foil cutter of FIG. 1;

FIG. 4 is a bottom view of the foil cutter of FIG. 1;

FIG. 5 is a cross-sectional side view of the foil cutter as seen along lines 5-5 of FIG. 2 as applied to a wine bottle; and

FIG. 6 is a cross-sectional side view of the foil cutter in use on the wine bottle of FIG. 5.

### DETAILED DESCRIPTION OF THE PREFERRED EMBODIMENT

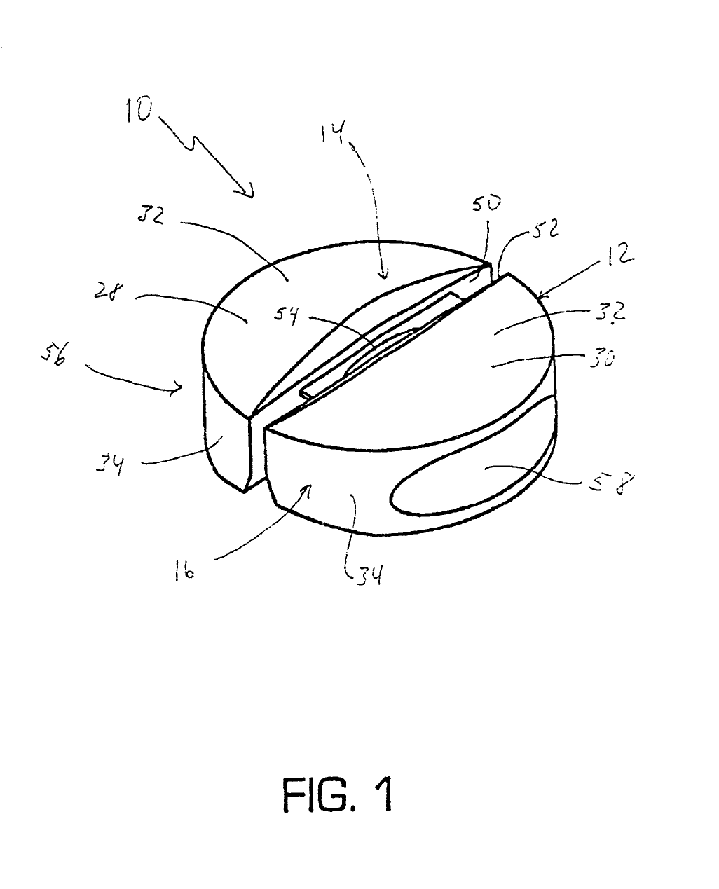

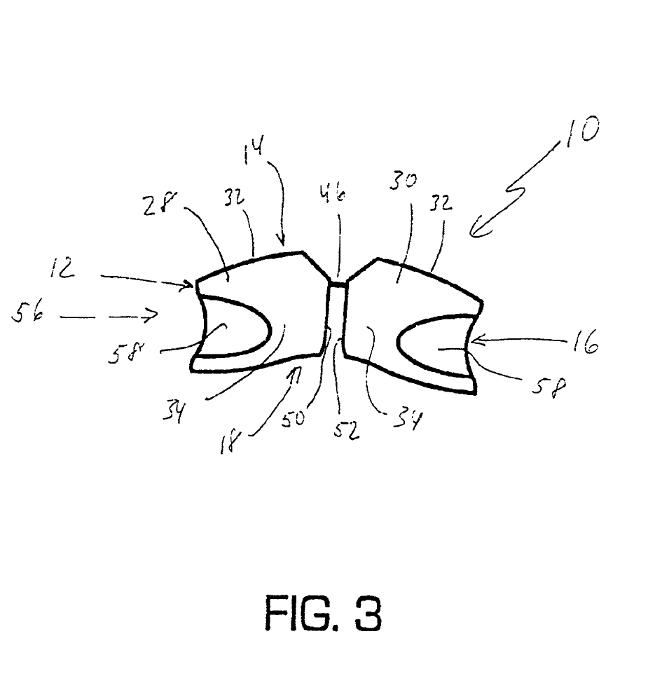

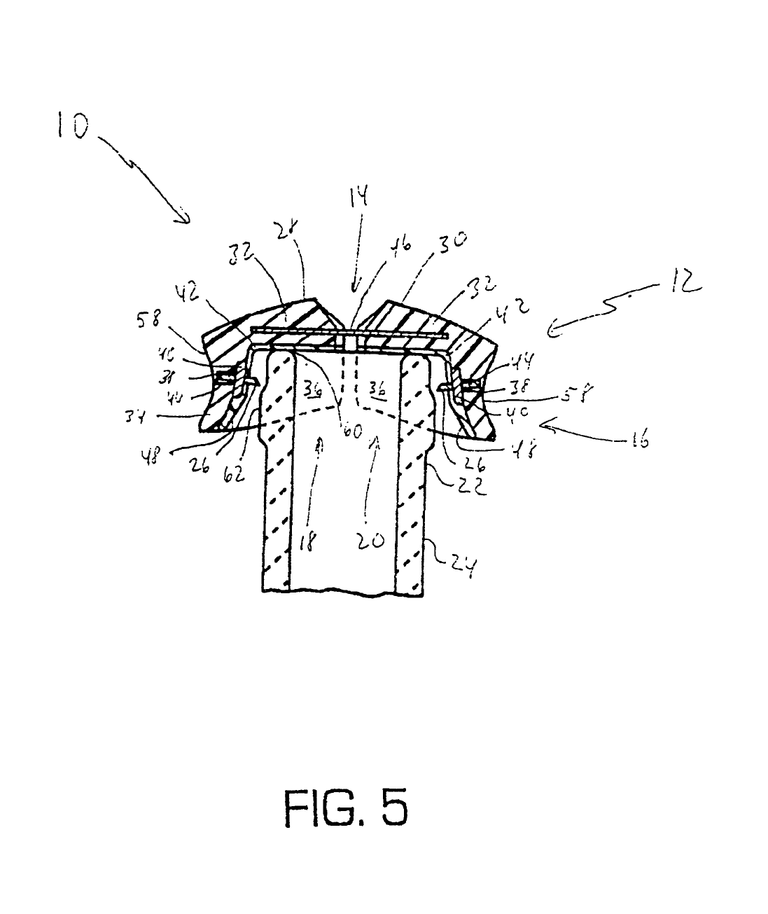

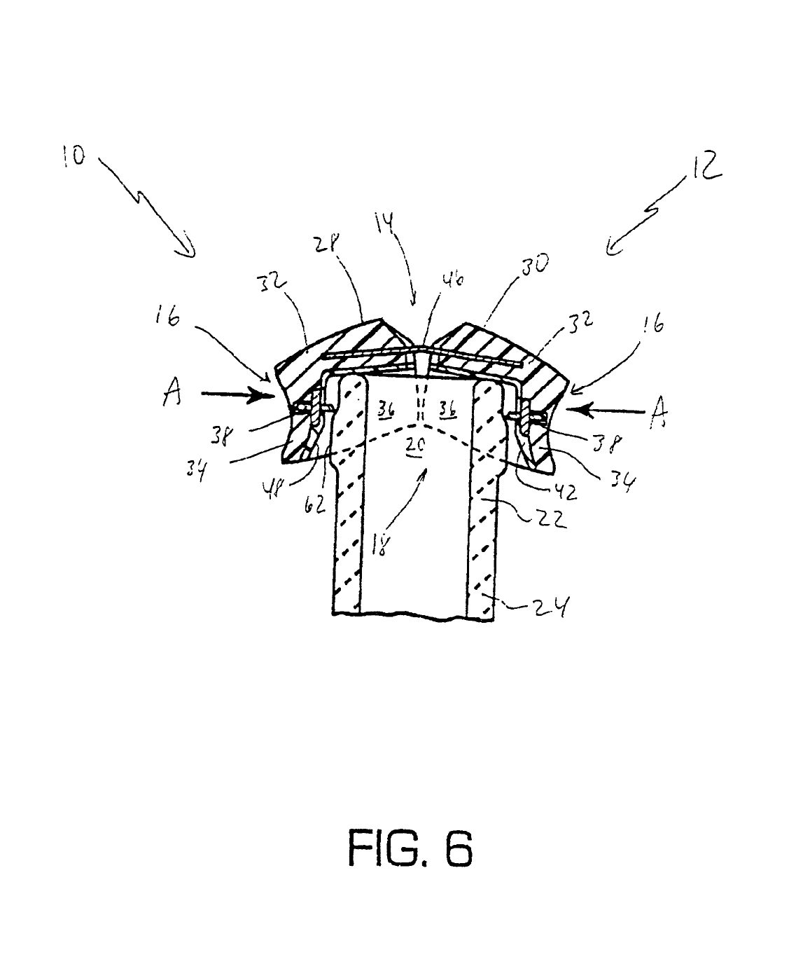

The general configuration of foil cutter 10 as a whole can be seen by a general viewing of the perspective, top, side, and bottom views of FIGS. 1-4 and the cross-sectional views of FIGS. 5-6.

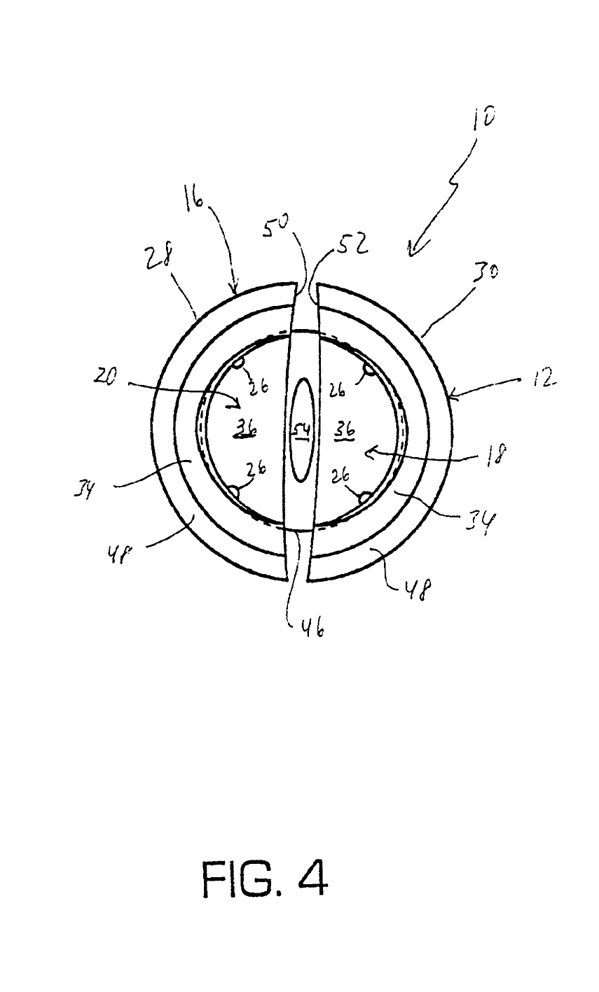

Cutter 10 comprises an essentially circular, disc-shaped body 12 (FIG. 1) with a substantially closed top 14, a substantially closed periphery 16, and an open bottom 18 (FIGS. 4-6). Top 14, periphery 16, and bottom 18 generally define a substantially circular interior cavity 20 that is substantially closed on all sides with the exception of open bottom 18. The diameter of cavity 20 (FIG. 5) is sufficiently large that the neck 22 of a normal wine bottle 24 can be loosely received in cavity 20.

A plurality of cutting edges 26 (FIG. 4), which preferably comprise the outer edges of cutting wheels, are spaced about cavity 20 and protrude therein. Cutter 10 is made operational by flexing body 12 inwardly by applying pressure to opposing sides of periphery 16 in the direction of arrows A-A (FIG. 6). The dimensions of cutter 10 are preferably on the order of two inches in diameter and three-quarters of an inch in height, a compact tool that combines easy handling with a secure feel. While these are the preferred dimensions, clearly the dimensions may vary and still remain within the scope of the appended claims. This concludes an overview of cutter 10; the details thereof will now be described.

Cutter body 12 comprises two substantially D-shaped body parts 28 and 30, which are mirror images of each other. Body parts 28 and 30 each comprise a top 32 with an integral, depending, arcuate flange 34, the combination of top and flange defining an interior, half-moon shaped recess 36 (FIGS. 4-6). Each recess 36 is bounded only by top 32 and flange 34.

A pair of cutting wheels 38 (FIGS. 4-5) are rotatably attached to each of body parts 28 and 30. Wheels 38 are each freely rotatable on axles 40, which are secured within flanges 34 and locked in place by a hard plastic cap 42 (FIGS. 5-6). Cap 42 is preferably sonic welded to the interior surfaces of body parts 28 and 30. A plurality of chambers 44, opening into interior cavity 20 through caps 42, are molded into flange 34 within each of which an associated cutting wheel 38 is free to rotate.

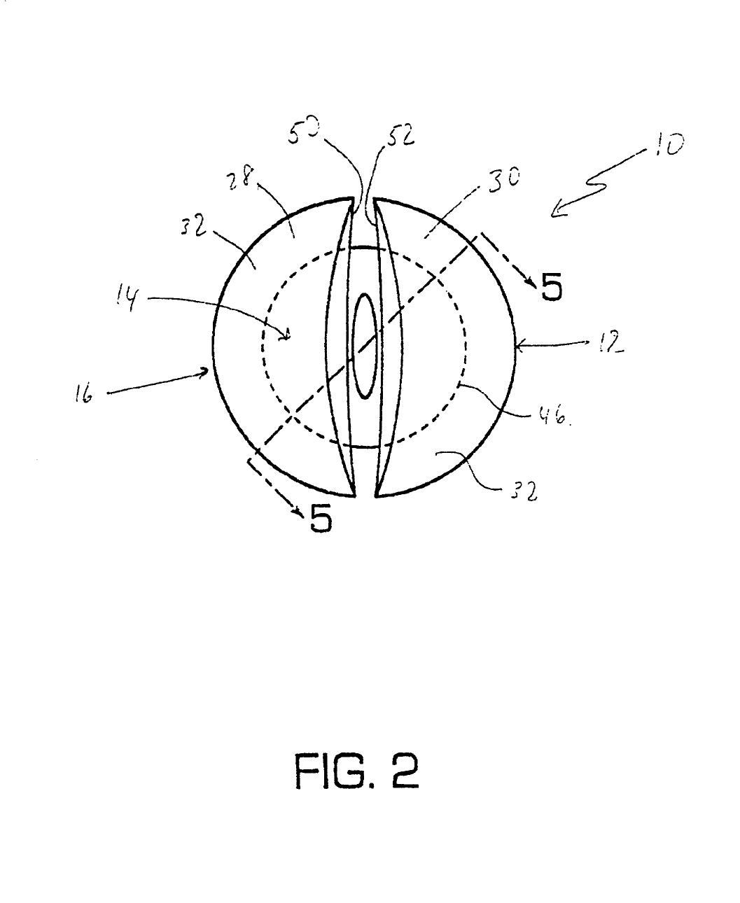

Body parts 28 and 30 are joined together to form the aforementioned disc-shaped body 12 by a circular leaf spring 46 (most clearly visualized through the combination of the dotted lines in FIGS. 2 and 4 and the cross-sectional edge views in FIGS. 5-6) molded into tops 32. When connected by leaf spring 46, the two half-moon shaped recesses 36 combine to form generally circular interior cavity 20. The lower edges 48 of flanges 34 are smooth for comfort and flared outwardly (FIGS. 5-6) to give interior cavity 20 a funnel-like configuration, which aids in placing cutter 10 on wine bottle neck 22.

Spring 46 performs three essential functions: it joins body parts 28 and 30 together to form a single cutter body 12, it spaces body parts 28 and 30 slightly apart along facing linear edges 50 and 52, providing a larger expanse of bendable area, and it flexes transversely of its plane (compare FIGS. 5 and 6), when pressure is applied as indicated by arrows A-A, spreading the flexure across the full diameter of spring 46. When flexed, flanges 34 approach each other, bringing cutting wheels 38 into contact with bottle neck 22, whereupon relative rotation between cutter 10 and bottle 24 will cut through any foil thereon. An oval aperture 54 may be stamped in spring 46 to increase its flexibility. Controlling the size and shape of aperture 54 permits the spring's resistance to flexibility to be finely tuned. When the applied pressure is released, spring 46 resumes its planar configuration and restores cutter 10 to the rest position shown in FIG. 5.

The exterior surface 56 of cutter 10 is contoured for ergonomic and aesthetic reasons. The overall configuration is smooth and without sharp edges or corners, so the propensity for cutter 10 to catch on disparate objects is virtually eliminated. Tops 32 are slightly domed to fit comfortably in the palm of the hand, and grooves 58 are provided in the exterior surface of flanges 34 as finger grips, which facilitate gripping of cutter 10.

Body parts 28 and 30 are conveniently molded of ABS having a high tensile strength, which may be coated with a rubberized paint to provide an easy and attractive surface for the hands of the user to grip. Plastic cap 42 may also be a form of ABS.

In use (FIGS. 5-6), cutter 10 is placed over neck 22 of wine bottle 24, until top 14 of cavity 20 rests upon mouth 60. Flanges 34 are depressed along arrows A-A bringing cutting edges 26 of cutting wheels 44 into contact with neck 22 just above the so-called drip ring 62. Rotating bottle and cutter in opposite directions severs the foil, leaving a cylindrical sleeve (not shown) around neck 22. When the top “cap” of the foil has been completely severed, cutter 10 is removed from bottle 24, the foil “cap” is discarded, and cutter 10 is returned to a drawer or pocket.

Those skilled in the art will appreciate that the conception, upon which this disclosure is based, may readily be utilized as a basis for the designing of other structures, methods and systems for carrying out the several purposes of the present invention. It is important, therefore, that the claims be regarded as including such equivalent constructions insofar as they do not depart from the spirit and scope of the present invention as defined in the appended claims.

Further, the purpose of the Abstract is to enable the U.S. Patent and Trademark Office, and the public generally, and especially the scientists, engineers and practitioners in the art who are not familiar with patent or legal terms or phraseology, to determine quickly from a cursory inspection the nature and essence of the technical disclosure of the application. The Abstract is neither intended to define the invention of the application, which is measured solely by the claims, nor is intended to be limiting as to the scope of the invention in any way.

It can be seen from the above that an invention has been disclosed which fulfills all the objects of the invention. It is to be understood, however, that the disclosure is by way of illustration only and that the scope of the invention is to be limited solely by the following claims:

I claim as my invention:

1. A foil cutter for cutting the foil on the neck of a wine bottle, comprising:
a substantially disc-shaped body, said body including a substantially closed top, a substantially closed annular periphery, and an open bottom, said top, said periphery, and said bottom defining a substantially circular interior cavity;
a plurality of cutting edges, said cutting edges being spaced about said substantially circular interior cavity and protruding therein, said substantially circular interior cavity having a diameter sufficiently large such that said neck of said wine bottle can be loosely received therein; and
said body being sufficiently flexible such that inward pressure applied to opposing portions of said annular periphery will bring said cutting edges into cutting contact with said foil on said neck of said wine bottle to cut said foil.

2. The foil cutter of claim 1 further comprising a leaf spring, and wherein said disc-shaped body comprises a pair of substantially D-shaped body parts, and said leaf spring connects said pair of substantially D-shaped body parts together to form said disc-shaped body.

3. The foil cutter of claim 2 wherein each of said pair of substantially D-shaped body parts comprise a generally planar top and an annular depending flange, portions of said leaf spring being molded within each of said generally planar tops of said substantially D-shaped body parts, said pair of substantially D-shaped body parts being spaced apart by another portion of said leaf spring.

4. The foil cutter of claim 3 wherein said annular depending flanges are flared outwardly to give said substantially circular interior cavity a funnel-like configuration.

5. The foil cutter of claim 3 wherein said leaf spring comprises a planar, circular metal spring.

6. The foil cutter of claim 5 wherein said leaf spring includes a centrally located aperture.

7. The foil cutter of claim 2 wherein each of said pair of substantially D-shaped body parts comprise a generally planar top and an annular depending flange which together define an interior, half-moon shaped recess, and, when said pair of substantially D-shaped body parts are connected by said leaf spring, said half-moon shaped recesses combine to form said substantially circular interior cavity.

8. The foil cutter of claim 7 wherein each of said pair of substantially D-shaped body parts are molded of ABS, said leaf spring is stamped from metal, and said leaf spring is molded within said generally planar top.

9. The foil cutter of claim 8 wherein said plurality of cutting edges comprise cutting wheels.

10. The foil cutter of claim 9 wherein said plurality of cutting wheels comprises four cutting wheels substantially equally spaced around said substantially circular interior cavity.

11. The foil cutter of claim 1 wherein said substantially closed top is slightly domed.

12. The foil cutter of claim 1 wherein the exterior surface of said substantially closed annular periphery includes grooves.

13. The foil cutter of claim 1 wherein said plurality of cutting edges comprise cutting wheels.

14. The foil cutter of claim 13 wherein said plurality of cutting wheels comprises four cutting wheels substantially equally spaced around said substantially circular interior cavity.

15. A foil cutter for cutting the foil on the neck of a wine bottle, comprising:
a substantially disc-shaped body having a substantially circular interior cavity adapted to fit over said neck of said wine bottle;
a plurality of cutting edges spaced about said substantially circular interior cavity and protruding therein; and
said body being sufficiently flexible such that pressure applied to said body brings said cutting edges into contact with said foil on said neck of said wine bottle.

16. The foil cutter of claim 15, wherein said body comprises a pair of D-shaped body parts, each of said body parts having at least two of said cutting edges positioned therein.

17. The foil cutter of claim 16, further comprising a spring coupling said pair of D-shaped body parts.

18. The foil cutter of claim 17, wherein said spring comprises a substantially planar metal spring.

19. The foil cutter of claim 18, wherein said metal spring has first and second portions thereof that are respectively imbedded in said pair of D-shaped body parts.

20. A foil cutter for cutting the foil on the neck of a wine bottle, comprising:
first and second D-shaped body parts;
a substantially planar spring coupled to said first and second body parts so as to render said body parts flexible towards and away from each other;
said body parts and said spring defining an interior cavity adapted to fit over said neck of said wine bottle; and
a plurality of cutting edges spaced about said interior cavity and protruding therein;
whereby flexing said body parts towards each other permits said cutting edges to come into contact with said foil on said neck of said wine bottle placed in said interior cavity.
